(19) United States
(12) Patent Application Publication
(10) Pub. No.: US 2010/0001653 A1
(43) Pub. Date: Jan. 7, 2010

(54) OPTICAL LIGHTING DEVICE

(75) Inventor: Achim Hilgers, Alsdorf (DE)

Correspondence Address: Philips Intellectual Property and Standards, P.O. Box 3001, Briarcliff Manor, NY, 10510-8001, US

(73) Assignee: KONINKLIJKE PHILIPS ELECTRONICS N.V., Eindhoven (NL)

(21) Appl. No.: 12/375,797

(22) PCT Filed: Aug. 15, 2007
(86) PCT No.: PCT/IB2007/053247

§ 371 Date: Jan. 30, 2009

(30) Foreign Application Priority Data
Aug. 25, 2006 (EP) 06119517.8

(51) Int. Cl. H05B 37/02; F21V 1/00; G02B 6/00

(52) U.S. Cl. 315/149; 362/235; 362/551

(57) ABSTRACT

The present invention relates to a optical lighting device comprising several solid state light sources (2) and at least one optical sensor (4) arranged between the solid state light sources (2) in approximately the same plane. An optical deflection unit (5, 13) is mounted in front of the sensor (4) and designed to deflect light laterally emitted by the solid state light sources (2) to the optical sensor (4). The deflection unit (5, 13) is designed to inhibit the transmission of ambient light to the optical sensor (4).

The present invention relates to the field of optical lighting devices comprising several solid state light sources like light emitting diodes (LED) in a planar or a curved plane. Such lighting devices are used for any kind of lighting applications, for example in the automotive area, in the field of professional lighting or in the area of consumer applications.

Conventional lighting devices such as for example signal lights or lamps are more and more equipped with LED light sources. The main advantages of these LED light sources are the very much higher efficiency and their increased lifetime. Because of the small LED dimensions and their flexible form factors novel and interesting opportunities are offered to lamp designers.

The original applications of LEDs as e.g. small signal lights have been expanded very much. Very often combinations of multiple LEDs, connected in series and/or parallel, are used to increase the light output and hence to realize physically bigger high brightness lighting devices as for example traffic lights. Also in the automotive area LED based lighting devices are implemented more and more. Currently they can be found as backlight, break light and in flashing light systems. First trials to use them as headlights have been made and the results are looking promising.

In additional a typical market for LED based light sources will be in the field of professional lighting as well as in the area of consumer applications, for example for atmosphere lighting at home and in shops. Especially at these latter applications the lighting devices have to fulfill higher requirements. In particular, a very good color quality, e.g. color rendering, is necessary. Further, it is of additional interest to adapt the color itself and/or the color temperature of such a lighting device to the user demanding. All this requires appropriate electronic driving and control circuits for the LED light sources of the device.

White light can be generated by means of a combination of few different LEDs with different colors. In principle the mix of these different colors allows to generate white light with the required color temperature and the demanded characteristic. Very often red (R), green (G) and blue (B) LEDs are used. More colors as for example amber (A) could be added to improve the color quality, e.g. the color rendering index. In principle other color combinations can be used as well. By means of such combinations the light output (luminous flux) and the color temperature of the white light can be adjusted. In the same manner every other color can be generated.

The adjustment of the color temperature requires an appropriate electronic driving and control circuit for each or for combinations of the LEDs of such lighting devices. In addition, a sensor based feedback loop may be implemented in order to measure the light characteristic in real time and to steer the light output towards the desired one. The sensors utilized for this task can be conventional photo sensitive devices, e.g. light sensors measuring the luminous flux or (true) color sensors measuring the spectral characteristic of the light. The sensed data are used to feed the control circuit of the lighting device, which adjusts the driving currents of the LEDs independently until the required light characteristic has been reached. The electronic driving currents of the LEDs can be modified with a vast variety of basic circuits, for example by pulse width modulation (PWM), by amplitude modulation (AM) or by direct current feeding.

For measuring the spectral characteristic of the light three channel RGB sensors are available. The precise optical function of these sensors is however limited to a small angle of incident of only about 10°. This results in a very inconvenient arrangement of the sensor in respect to the LED light sources since sensor and light source have to be placed face to face, i.e. 180° against each other. This causes unwanted shadowing effects and requires additional mounting supports including electrical connections for the sensors.

In order to overcome this disadvantage, WO 02/099333 A1 discloses an optical lighting device with the optical sensor being arranged in the same plane as the LED light sources. A planar or curved optically transparent element with an antireflection coating is positioned between a main condenser lens and the output opening of the lighting device. This element is used as a partial reflector which reflects a small portion of the light emitted by the LEDs back to impinge at a small angle of incidence on the optical sensor.

It is an object of the present invention to provide an optical lighting device with one or several optical sensors which do not cause unwanted shadowing of the light sources of the lighting device and which allow the measurement of the light of these light sources with reduced influence from ambient light.

The object is achieved with the optical lighting device according to claim 1. Advantageous embodiments of the optical lighting device are the subject matter of the sub claims or are described in the subsequent description and examples.

The optical lighting device of the present invention comprises several solid state light sources arranged in a planar or curved plane, at least one optical sensor arranged between said solid state light sources at least approximately in said plane and a deflection unit mounted in front of said optical sensor to deflect a portion of light emitted by said light sources to said optical sensor. The deflection unit of the proposed optical lighting device is arranged and designed to deflect said portion of light from light laterally emitted by said solid state light sources and to reduce an amount of ambient light impinging on the optical sensor from a front side. This can be achieved by a reflector unit having an optically non transparent layer or element arranged at a front side separately or as a part of said reflector unit. Alternatively, a fiber bundle of a multiplicity of fine fibers, for example glass or polymer fibers, can be used as deflector unit. In this case a separate non transparent layer is not necessary since the ambient light impinging from the front side cannot couple into the fibers and therefore does not reach the sensor.

With the arrangement of the deflection unit in front of said optical sensor(s) the angle of incidence of the deflected light on the sensitive area of said sensor is approximately about 0° (relative to the normal of said area). This allows the use of optical sensors with filters adapted to such an angle of incidence, i.e. commercially available optical sensors, e.g. common RGB sensors. Due to the arrangement and design of the deflection unit the optical sensors can be mounted laterally to the light sources in the same plane and also on the same substrate, for example a printed circuit board (PCB). Since the deflection unit is arranged and designed to deflect a portion of light from light laterally emitted by the light sources, the deflection unit is arranged close to the plane of the solid state light sources and therefore does not cause unwanted shadowing effects. The optically non transparent layer or element arranged at the front side of the reflector unit drastically reduces the amount of ambient light which impinges on the optical sensor. This reduces the sensitivity of the sensors towards ambient light effects, which could disturb the measurement and hence the color control of the solid state light sources. Therefore, malfunctions of the sensor caused by ambient light are reduced. Generally, the proposed optical reflection unit also reduces the requirements to color control algorithms. The same applies when a fiber bundle is used.

The optical lighting device of the present invention can comprise one or several optical sensors. The sensors can be for example ordinary flux sensors or combined RGB sensors. The filters of the RGB sensors can be optimized in such a manner, that they match the human eye sensitivity. Basically the commercially available optical sensors use the light sensitivity of semiconducting materials. The semiconducting material can be optically irradiated through a window. Depending on the intensity of the irradiation the impedance of the semiconducting material changes its value.

In order to adapt the sensor sensitivity to special wavelengths or spectra optical filters can be used. The filters can consist either of colored glass or plastics blocking parts of the light spectrum and thus transmitting the desired spectra or of interference filters. Interference filters are basically made of metallic coatings for making fully reflective mirrors and neutral density filters, and of thin film interference coatings, which are mainly used. Interference coatings are composed of a stack of thin layered materials, each with a thickness in the order of the wavelength of light, usually of a quarter of the wavelength of the light. Although each material is intrinsically colorless, the reflection at each interface leads to interfering waves so that some wavelengths of light are selectively reflected and others (the desired ones) are transmitted. Appropriate optical sensors are commercially available for example from MAZeT GmbH, Jena, Germany or from Avago Technologies, San Jose, USA.

The solid state light sources of the proposed optical lighting device are preferably light emitting diodes (LEDs). This includes ordinary low power semiconductor devices and especially the new high power devices as for example from LUMILED™. Further, LEDs with optical color filters as well as those with coated layers to change the original stimulated color to the required one are included. In general also PLEDs (Poly LEDs), OLEDs (Organic LEDs) or QDLEDs (Quantum Dot LEDs) can be used.

In one embodiment of the present lighting device, the deflection unit is directly attached to the optical sensor. The attachment can be realized by means of sticking (gluing) the deflection unit on top of the sensor or using mechanical fixtures, which are clapped on or clamped to the sensor.

The reflector unit comprises a head portion with one or several inner reflecting surfaces which reflect the laterally incoming light towards the optical sensor. The reflecting surfaces can be formed as mirrors or as strongly diffuse scattering planes. In one embodiment of the lighting device the reflector unit comprises a body of optically transparent material. In this embodiment the portion between the reflecting head portion and the optical sensor may serve as an optical waveguide for the reflected light.

In a further advantageous embodiment the optical reflector unit comprises optically diffuse scattering material between the reflecting surfaces and the optical sensor. This diffuse scattering material, for example frosted glass, advantageously mixes the incoming light from the different light sources homogenously before impinging on the optical sensor.

In a further embodiment of the lighting device the non transparent layer or element in front of the reflector unit is directly attached to the reflector unit. This non transparent layer or element preferably fully covers the top surface of the reflector unit in order to avoid the transmission of ambient light through the reflector unit to the optical sensor. The non transparent layer can be formed as a mirror for the ambient light. Furthermore, this non transparent layer can form the reflecting surface towards the optical sensor to reflect the laterally incoming light of the solid state light sources to the optical sensor.

In a further embodiment of the optical lighting device the arrangement of solid state light sources is surrounded by a lamp reflector in order to achieve a desired geometrical characteristic of the light output of the optical lighting device. In this embodiment the lamp reflector is locally adapted to reflect a portion of the light impinging from the light sources laterally to the deflection unit of the optical sensor which then deflects this light to the optical sensor. With this measure the amount of light collected by the deflection unit for the optical sensor can be increased.

The optical lighting device according to the present invention can also already include a control circuitry for controlling the light output of the different light sources in order to achieve a desired optical characteristic of the overall output of the optical lighting device. The outputs of the one or several optical sensors are delivered to this control circuit which in turn controls the solid state light sources appropriately dependent on the measured data and the demanded output characteristic. Through this feedback control the requirements in particular with respect to the color output of the optical lighting device can be fulfilled. The design of such a control circuit is known in the art as already indicated in the introductory portion of the present description.

These and other aspects of the invention will be apparent from and elucidated with reference to the embodiments described herein after.

The proposed optical lighting device is described in the following by way of examples in connection with the accompanying figures without limiting the scope of protection as defined by the claims. The figures show:

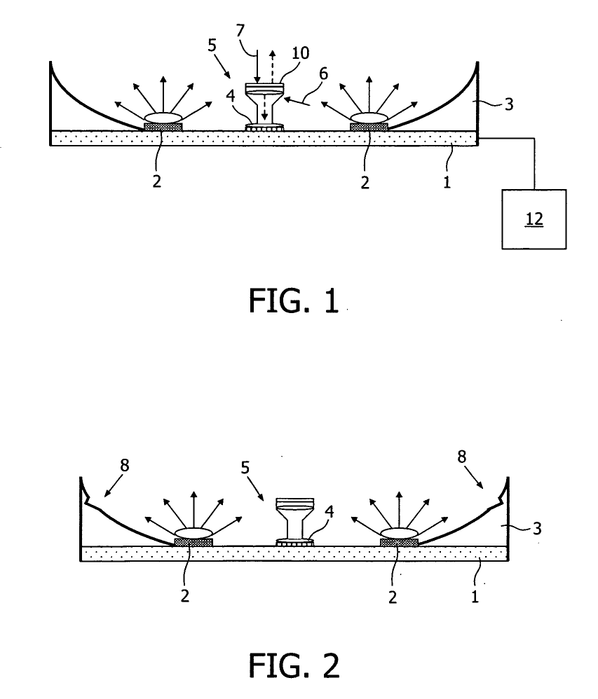

FIG. 1 a schematical example of a first embodiment of the present invention;

FIG. 2 a schematical example of a second embodiment of the present invention;

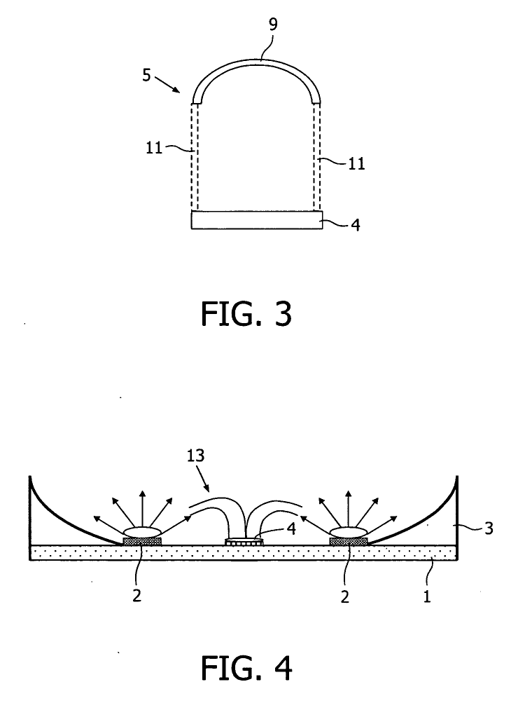

FIG. 3 a schematical view of an exemplary reflector unit of the proposed optical lighting device; and

FIG. 4 a schematical example of a third embodiment of the present invention.

FIG. 1 shows a schematic view of an example of the proposed optical lighting device. The optical lighting device is composed of several LED light sources 2 which are mounted on the same substrate 1, for example a printed circuit board. In the present example for case of simplicity only two LED light sources 2 are shown. A RGB sensor 4 is mounted on the same substrate 1 laterally between the LED light sources 2. The LED light sources 2 and the RGB sensor 4 are surrounded by a lamp reflector 3 of the optical lighting device. Usually such a lamp reflector 3 is adapted to mirror and bend the light of the LED light sources 2 in such a way, that the light output (luminous flux) of the optical lighting device is maximized and/or that the angle of reflection fulfills given requirements, for example bundles the light beam to a beam cone of 10°, 45° etc.

The RGB sensor 4 comprises interference filters on its radiation sensitive area in a known manner, in order to correctly measure the R, G and B portions of the incoming light. Theses interference filters are normally designed for an angle of incidence of around 0° with respect to the normal on the radiation sensitive area of the sensor to work correctly.

In order to be able to correctly measure the light laterally emitted by the LED light sources 2 an optical reflector unit 5 is mounted on top of the RGB sensor 4 in the present embodiment. This optical reflector unit 5 is designed to reflect laterally incoming light towards the radiation sensitive area of the sensor 4. Since the reflector unit 5 is arranged in front of the RGB sensor 4, the reflected light impinges at an angle of incidence of about 0°±10° on the radiation sensitive area of the RGB sensor 4. With laterally incoming light it is meant that the light emitted by the LED light sources 2 propagates at an angle of 90°±45°, preferably at an angle of 90°±25°, with respect to the normal of the radiation sensitive are of the RGB sensor 4 or of the surface of the substrate 1. Some propagation directions of the light emitted by the LED light sources 2 of the optical lighting device are indicated with arrows in FIG. 1.

The laterally incoming light is reflected at a inner top surface of the reflector unit 5 towards the optical sensor 4. This is also indicated with arrows in FIG. 1. To this end the head portion of the reflector unit 5 comprises one or several reflective surfaces for the incoming light, for example an appropriate highly reflecting metallic surface. In addition, the reflector unit 5 is designed to inhibit the propagation of ambient light 7 impinging on the reflector unit 5 from the front of the optical lighting device as indicated in FIG. 1. The reflector unit 5 comprises an optically non transparent layer 10 on its top surface. This layer 10 can be designed as a mirror for the ambient light 7 so that incoming ambient light 7 from the front is fully reflected and therefore does not disturb the measurement of the sensor 4. The design of the proposed reflector unit 5 ensures that only light coming from the side, i.e. at an angle of incidence which lies in the above range for laterally incoming light, preferably at an angle of approximately 90°, is directed to the optical sensor 4 for measurement.

The LED light sources 2 may be concentrically arranged around the reflector unit 5 with the sensor 4. In such a case with a rotationally symmetric reflector unit 5 light of all light sources 2 can be detected. An advantage of the proposed optical lighting device is that different sensors, either based on colored glass or on interference filters, can be used, since the reflector unit 5 is attached simply on top of the sensor 4 and ensures an angle of incidence of around 0° (±10°) on the sensor. The attachment itself can be realized by means of sticking (gluing) the reflector unit 5 on top of the sensor 4 or using mechanical fixtures.

In order to provide a control of the light emission of the LED light sources 2, a control unit 12 may be connected to the light sources 2 and the sensor 4 of the lighting device. This control unit 12 controls the light emission of the light sources 2 dependent on the measurement signal of the sensor 4. The electrical connection between the control unit 12, the RGB sensor 4 and the LED light sources 2 is realized through strip lines integrated in the common substrate 1.

The reflector unit 5 of this lighting device may have a dome like shape of the head portion 9 as indicated in FIG. 3. With such a form a concave mirror can be realized as the reflecting surface which ensures that laterally incoming light is reflected towards the optical sensor 4. Nevertheless the optical reflecting inner surface may also be composed of several smaller reflecting elements to ensure the proper reflection towards the optical sensor 4. The reflecting surface can also be designed for diffused scattering of the laterally incoming light. With such an inner surface a significant portion of the incoming light is scattered towards the optical sensor. By realizing the reflecting inner surface with a metallic layer which is non transparent for the light, this layer also inhibits the transmission of ambient light impinging from the front of the lighting device on the reflector unit. This ambient light is absorbed and/or reflected back by the metallic layer and does not disturb the measuring signal of the light sensor.

The connection of the head portion 9 of the reflector unit 5 with the optical sensor 4 may be realized by 3 or more bars 11 which are fixed on the sensor 4. It is also possible to provide the reflector unit 5 with a body of optically transparent material, for example a glass or plastic material. In this case the top surface of this body is appropriately formed, for example dome like as in FIG. 3, and covered with an optically reflecting layer. The portion between the reflecting head and the optical sensor may then serve as an optical waveguide. To this end this lower portion may also be additionally coated on the side with a reflecting layer.

In addition to the optical reflector unit 5 a modification of the lamp reflector 3 of the lighting device can be performed to optimize the sensor characteristic. By means of a local modification of the lamp reflector as shown in FIG. 2, it can be guaranteed, that the centrally located RGB sensor 4 detects the spectrum of each light source. The partly adapted reflector portions or elements 8 of the lamp reflector 3 are designed such that the light reflected from these portions or elements arrives at the reflector unit 5 at an appropriate angle of incidence to be reflected by this reflector unit 5 to the optical sensor 4. In the present embodiment the adapted reflector portions or elements 8 are concentrically arranged on the surface of the lamp reflector 3.

The proposed design and arrangement of the reflector unit 5 and optical sensor 4 can be applied to all optical lighting devices with solid state light sources where an optical feedback is necessary in order to control the light output, in particular the color, of such a lighting device.

FIG. 4 shows a schematic view of a further embodiment in which a fiber bundle 13 is used instead of the reflector unit of the preceding examples. With such a fiber bundle 13 being composed of a high number of fine fibers the light from the LED light sources 2 can be deflected to ensure an angle of incidence of around 0° (±10°) on the sensor 4. With the high number of fine fibers a mixing effect of the light is achieved.

While the invention has been illustrated and described in detail in the drawings and foregoing description, such illustration and description are to be considered illustrative or exemplary and not restrictive; the invention is not limited to the disclosed embodiments. For example, it is also possible to provide one deflection unit for several sensors arranged close to one another or to arrange the sensors not centrically with respect to the arrangement of the light sources. Furthermore, the different embodiments described above can also be combined.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope of these claims.

### LIST OF REFERENCE SIGNS

1 substrate
2 LED light source
3 lamp reflector
4 RGB sensor
5 optical reflector unit
6 laterally incoming light
7 ambient light
8 partly adapted reflector elements
9 reflecting head portion of reflector unit
10 non transparent layer
11 bars
12 control unit
13 fiber bundle

1. An optical lighting device comprising
a plurality of solid state light sources arranged in a planar or curved plane,
at least one optical sensor arranged among said plurality of solid state light sources at least approximately in said plane, and
a deflection unit mounted in front of said optical sensor to deflect a portion of light emitted by said solid state light sources to said optical sensor,
wherein the deflection unit is arranged and configured to deflect said portion of light from light laterally emitted by said plurality of solid state light sources such that said deflected portion of light impinges at an angle of incidence of 0°±10° on a sensitive area of said optical sensor and to reduce an amount of ambient light impinging on the optical sensor.

2. The optical lighting device according to claim 1, wherein said deflection unit is a reflector unit (5) having an optically non-transparent layer coated thereon.

3. The optical lighting device according to claim 1, wherein said deflection unit is a fiber bundle.

4. The optical lighting device according to claim 1, wherein said deflection unit is attached to said optical sensor.

5. The optical lighting device according to claim 1, wherein said solid state light sources and said optical sensor are arranged on a common substrate.

6. (canceled)

7. The optical lighting device according to claim 2, wherein said optically non transparent layer is configured to reflect said portion of light laterally emitted by said solid state light sources to said optical sensor.

8. (canceled)

9. The optical lighting device according to claim 2, wherein the reflector unit comprises a body of optically transparent material attached to a front side of said optical sensor and comprising a first portion and a second portion, said first portion being configured to reflect or scatter said portion of light laterally emitted by said plurality of solid state light sources to said optical sensor.

10. The optical lighting device according to claim 9, wherein said second portion forms an optical waveguide between said first portion and said optical sensor.

11. The optical lighting device according to claim 2, wherein the reflector unit comprises a diffuse scattering material arranged between a reflecting surface thereof and the optical sensor.

12. The optical lighting device according to claim 1, further comprising a lamp reflector surrounding said plurality of solid state light sources for achieving a desired geometrical characteristic of a light output of the optical lighting device, said lamp reflector being locally adapted to reflect a portion of the light laterally to the deflection unit.

13. The optical lighting device according to claim 1, wherein the optical sensor and the solid state light sources are electrically connected to a control circuit for controlling an amount of light emitted by the solid state light sources based at least partially on at least one signal received from the optical sensor to achieve a desired spectral characteristic of a light output of the optical lighting device.
